(19) United States
(12) Patent Application Publication
(10) Pub. No.: US 2004/0098960 A1
(43) Pub. Date: May 27, 2004

(54) Airfoil-shaped rotary cutting blade

(75) Inventor: Bela I. Csonka, Phoenix, AZ (US)

Correspondence Address: Daniel S. Jones, Michael Best & Friedrich LLP, 100 East Wisconsin Avenue, Milwaukee, WI, 53202-4108, US

(73) Assignee: Ariens Company, Brillion, WI

(21) Appl. No.: 10/301,050

(22) Filed: Nov. 21, 2002

(51) Int. Cl. A01D 34/73

(52) U.S. Cl. 56/295

(57) ABSTRACT

A rotary cutting blade includes an airfoil shape having a leading edge and a trailing edge. The trailing edge includes a cutting edge for cutting vegetation. The rotary cutting blade may be comprised of a steel flat portion and an epoxy/plastic curved portion co-molded onto the steel flat portion to give the rotary cutting blade its airfoil shape. The rotary cutting blade may also include a transverse member, such as a post, mounted on at least one end of the rotary cutting blade and perpendicular to the plane about which the rotary cutting blade rotates. A brush may be mounted on the post. The rotary cutting blade may be used in connection with a lawnmower, wherein the cutting edge may be used to cut through grass and the brush may then be used to remove grass and other debris from the inner surface of the lawnmower deck. A method for operating the rotary cutting blade is further provided.

### BACKGROUND OF THE INVENTION

The invention relates to airfoil-shaped rotary cutting blades.

### SUMMARY OF THE INVENTION

The present invention provides an airfoil-shaped rotary cutting blade having a leading edge and a trailing edge. The terms leading edge and trailing edge refer to the common aerodynamic designations for bodies having a traditional airfoil shape. However, the cutting blade may rotate in a direction opposite to the direction of a traditional airfoil shape. The terms leading edge and trailing edge do not refer to the direction of travel of the cutting blade. Therefore, the trailing edge of the airfoil may be the front cutting edge of the cutting blade, and the leading edge of the airfoil may be the rear non-cutting edge of the cutting blade.

The trailing edge includes a cutting edge for cutting vegetation. The rotary cutting blade may include a steel flat portion and an epoxy/plastic curved portion co-molded onto the steel flat portion to give the rotary cutting blade its airfoil shape. The rotary cutting blade may also include a transverse member, such as a post, mounted on at least one end of the rotary cutting blade and perpendicular to the plane about which the rotary cutting blade rotates. A brush may be rigidly mounted on the post, or may be mounted to the post for rotation with respect to the post.

The rotary cutting blade may be used in a lawnmower including a deck, wheels supporting the deck, an engine mounted on the deck, and a drive shaft rotated by the engine and extending below the deck. The rotary cutting blade is mounted below the deck for cutting grass or other vegetation, and rotates in response to rotation of the drive shaft. The brush mounted on at least one end of the blade then may be used to remove grass and other debris from the inner surface of the deck.

The invention also provides a method for operating the rotary cutting blade including providing an airfoil-shaped rotary cutting blade with a leading edge and a trailing edge, defining a cutting edge on the trailing edge of the airfoil, and rotating the blade such that the trailing edge of the airfoil is in front of the leading edge of the airfoil to cut vegetation with the cutting edge of the blade. The method may also include providing a rigid metal blade portion and interconnecting a curved portion to the rigid metal blade portion to form the airfoil shape. The interconnecting step then may include molding the curved portion onto the rigid metal portion. Alternatively, the method may include forming a single-piece blade in the shape of an airfoil.

Once the blade is formed, the method may include interconnecting a transverse member to an end of the blade, interconnecting a brush to the transverse member, surrounding the blade with a shroud, and cleaning the inner surface of the shroud with the brush as the blade rotates. Finally, the method may include providing a pressure differential above and below the blade in response to the rotation of the blade such that the vegetation below the blade is lifted toward the blade.

Independent features and independent advantages of the present invention will become apparent to those skilled in the art upon review of the following detailed description and drawings.

### BRIEF DESCRIPTION OF THE DRAWINGS

FIG. 1 is a perspective view of a lawnmower embodying the present invention.

FIG. 2 is a cross-section view taken along line 2-2 in FIG. 1.

FIG. 3 is a cross-section view taken along line 3-3 in FIG. 2.

FIG. 4 is a perspective view of the rotary cutting blade.

FIG. 5 is a cross-section view similar to FIG. 2 and illustrating an alternative construction of the rotary cutting blade.

FIG. 6 is an enlarged view of an end portion of the blade illustrated in FIG. 5.

FIG. 7 is a view similar to FIG. 6 and illustrating an alternative construction of the end portion of the rotary cutting blade.

FIG. 8 is a cross-section view similar to FIG. 2 and illustrating an alternative construction of the rotary cutting blade.

FIG. 9 is an side view illustrating an alternative construction of the rotary cutting blade.

FIG. 10 is a perspective view of the blade illustrated in FIG. 9.

FIG. 11 is a perspective view of a multi-blade lawnmower embodying the present invention.

FIG. 12 is a perspective view of a riding lawnmower embodying the present invention.

Before the embodiments of the invention are explained in detail, it is to be understood that the invention is not limited in its application to the details of construction and the arrangements of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

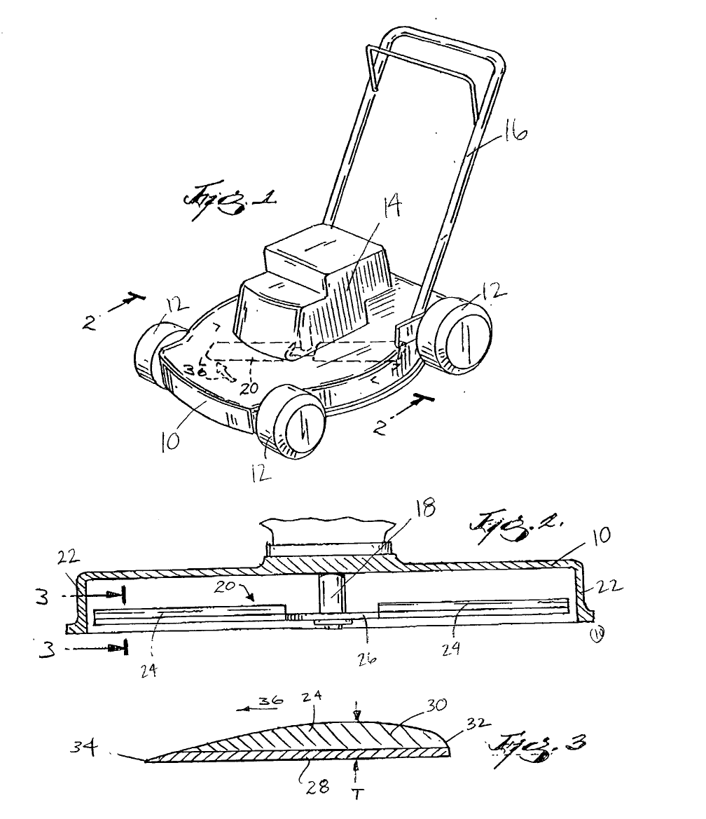

FIG. 1 illustrates a lawnmower that includes a deck 10 supported by wheels 12, an engine 14 supported by the deck 10, and a handle 16 extending up from the deck 10 to facilitate pushing, pulling, and otherwise manipulating the lawnmower. Although a walk-behind lawnmower is illustrated in FIG. 1, the invention has applications to riding lawnmowers as well, and can also be used in other vegetation-cutting apparatuses. Broadly interpreted, the invention disclosed herein may be used in substantially any application that employs a rotary cutting blade. The illustration of a lawnmower in FIG. 1 should therefore be considered an exemplary embodiment and should not be regarded as limiting.

As seen in FIG. 2, the lawnmower includes a drive shaft 18, which may be the power take-off shaft of the engine 14 (FIG. 1) itself, or a shaft that is rotated by the engine 14 (FIG. 1) through a power transmission. The drive shaft 18 extends down through the deck 10. A rotary cutting blade 20 is affixed to the drive shaft 18 and rotates in response to rotation of the drive shaft 18. The deck 10 includes depending flanges 22 that surround the rotary cutting blade 20 and drive shaft 18, but the vegetation (e.g., grass) below the lawnmower is exposed to the rotary cutting blade 20.

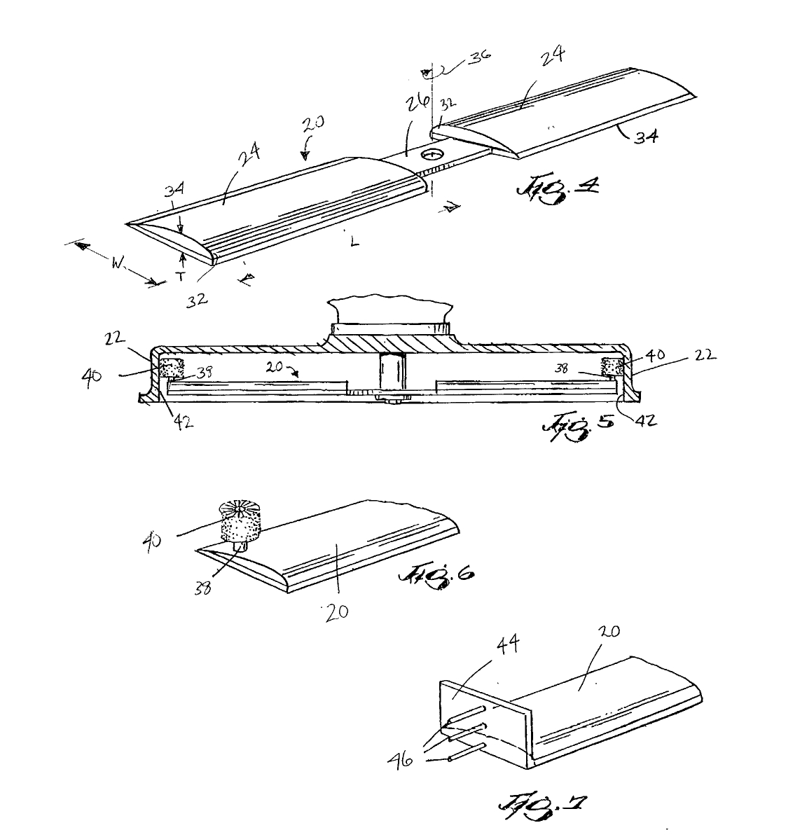

FIGS. 3 and 4 better illustrate the rotary cutting blade 20. The rotary cutting blade 20 includes two airfoil-shaped portions 24 connected by a coupling portion 26 that is mounted to the drive shaft 18. The airfoil-shaped portions 24 each include a length L, a width W, and a thickness T measured perpendicular to the length L and width W. The airfoil cross-section (FIG. 3) is substantially constant along the entire length L of the airfoil-shaped portion 24. The two airfoil-shaped portions 24 are substantially identical to each other, so only one is described in detail below.

With reference to FIG. 3, the airfoil-shaped portion 24 of the rotary cutting blade 20 includes a relatively flat portion 28 made of a rigid material (e.g., steel) and a curved portion 30 interconnected with the relatively flat portion 28 to give the composite rotary cutting blade 20 an airfoil shape. Using the traditional designations from aerodynamics, the airfoil-shaped portion 24 of the rotary cutting blade 20 includes a leading edge 32 and a trailing edge 34. The thickness T of the airfoil-shaped portion 24 is at a minimum at the trailing edge 34, and increases along a smooth curve to the maximum thickness T between the leading edge 32 and the trailing edge 34. The thickness T then decreases toward the leading edge 32. The leading edge 32 is rounded similar to a traditional airfoil.

The leading edge 32 of the airfoil-shaped portion 24 defines a non-cutting edge of the rotary cutting blade 20. The curved portion 30 may include an epoxy/plastic material molded (e.g., co-molded) or otherwise mounted onto the relatively flat portion 28. Alternatively, the rotary cutting blade 20 may be manufactured as a single, unitary piece by, for example, casting or molding the rotary cutting blade 20 out of metal, plastic, or another castable or moldable material. Although the illustrated airfoil-shaped portion 24 includes a relatively flat portion 28, an alternative construction may include a non-flat rigid part to which the curved portion 30 is affixed. In that case, material would have to be molded around the rigid part to create the airfoil shape.

The trailing edge 34 of the airfoil-shaped portion 24 includes a cutting edge to facilitate cutting the vegetation. The relatively flat portion 28 or the non-flat rigid part may be sharpened to provide the cutting edge.

In operation, the drive shaft 18 rotates the rotary cutting blade 20 in a cutting direction that moves the airfoil-shaped portions 24 through the air in the opposite direction compared to the traditional aerodynamic system. In other words, the rotary cutting blade 20 rotates such that the airfoil trailing edge 34 rotates in front of the airfoil leading edge 32 so that the rotary cutting blade 20 leads with the cutting edge to cut the vegetation.

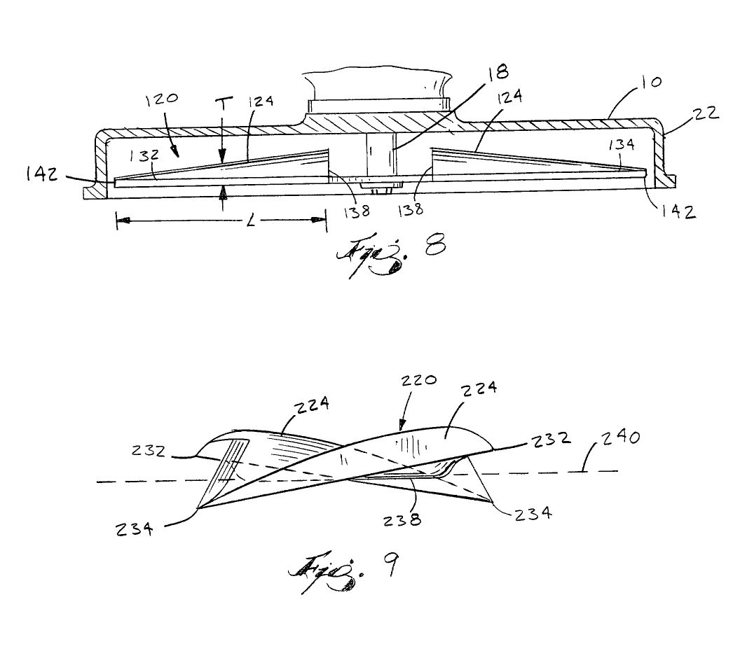

FIGS. 5 and 6 illustrate an alternative construction of the rotary cutting blade 20 in which a transverse member, such as the illustrated post 38, extends perpendicular to the rotary cutting blade 20. A brush 40 is supported by the post 38 and is free to rotate about the post 38. As the rotary cutting blade 20 rotates, the bristles of the brush 40 extend toward an inner surface 42 of the depending flanges 22 to knock away grass clippings and other debris that collects on the inner surface 42. It is not necessary for the bristles to contact the inner surface 42; contacting only the grass clippings collected the inner surface 42 may be sufficient. If the bristles contact the inner surface 42, excessive drag may be created which could reduce mower efficiency.

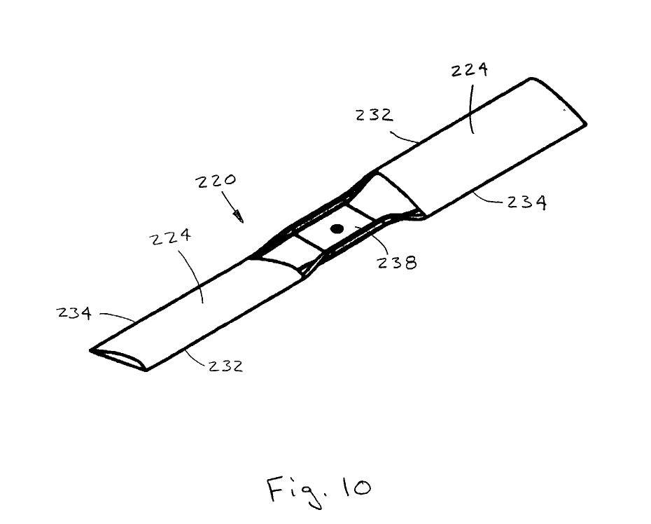

FIG. 7 illustrates another version of the rotary cutting blade 20 in which a transverse member, such as the illustrated winglet 44 or end plate extends perpendicular to the rotary cutting blade 20. Interconnected to the winglet 44 are bristles, such as the illustrated cords 46 or lines, made of a wear-resistant material (e.g., Nylon). The cords 46 extend toward the inner surface 42 of the depending flanges 22 to clean the inner surface 42 as the rotary cutting blade 20 rotates. In this regard, the cords 46 may be referred to as another construction of the brush 40 illustrated in FIGS. 5 and 6.

FIG. 8 illustrates an embodiment of the invention in which a cutting blade 120 includes airfoil-shaped portions 124 that decrease in thickness as the cutting blade 120 extends outwardly from the drive shaft 18. The airfoil-shaped portions 124 include a leading edge 132, a trailing edge 134, an inner end 138 and an outer end 142. The inner ends 138 are near the drive shaft 18, and the outer ends 142 are near the flanges 22. As shown in FIGS. 2-4, the thickness T of the airfoil-shaped portion 24 varies along the cross-section in the direction of the width W from the leading edge to the trailing edge. As shown in FIG. 8, the thickness T of the airfoil-shaped portion 124 may also vary (e.g., linearly as illustrated, or non-linearly) in the direction of the length L from the inner end 138 to the outer end 142. FIG. 8 is a side view and illustrates the variance in the maximum thickness T along the length of the airfoil-shaped portion 124.

The airfoil-shaped portion 124 having varying thickness helps equalize the pressure differential along the cutting blade 120. The airfoil-shaped portion 124 creates a pressure differential above and below the airfoil-shaped portion 124 that is a function of the surface area of the airfoil-shaped portion 124 and the velocity of the airfoil-shaped portion 124. The thickness T of the airfoil-shaped portion 124 is greater near the inner end 138 than near the outer end 142. Since the bottom of the blade 120 is relatively flat, increasing the thickness T of the airfoil-shaped portion 124 increases the surface area of the top of the blade 120 in relation to the bottom. The cutting blade 120 rotates about the drive shaft 18, so the velocity of the cutting blade 120 is greater near the outer end 142 than near the inner end 138. Since the difference in surface area between the top and bottom is greater near the inner end 138, the greater surface area helps increase the pressure differential near the inner end 138 to compensate for the higher velocity near the outer end 142. Therefore, the airfoil-shaped portion 124 illustrated in FIG. 8 helps equalize the pressure differential along the cutting blade 120.

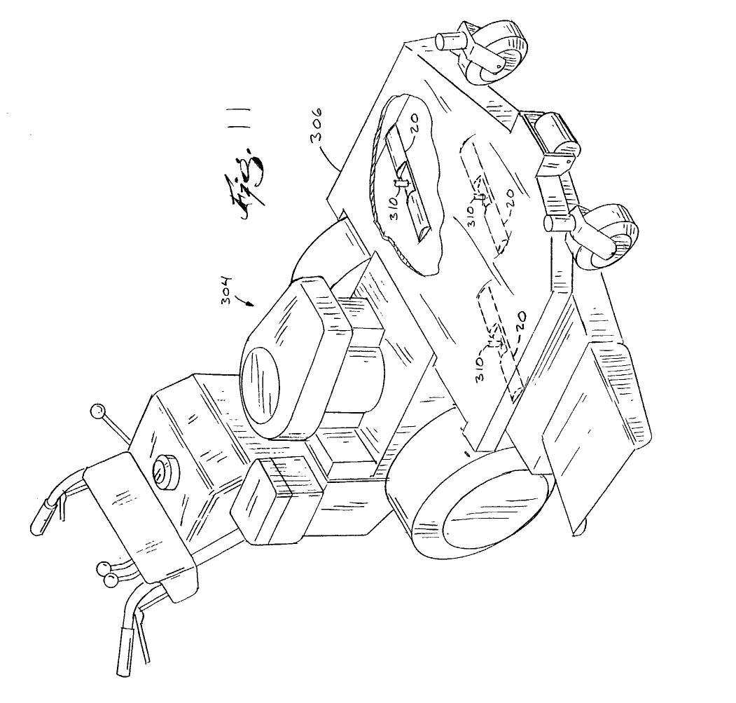

FIGS. 9 and 10 illustrate an embodiment in which a cutting blade 220 also includes an airfoil-shaped portion 224 having a leading edge 232 and a trailing edge 234. The cutting blade 220 is pitched, or tilted, such that the trailing edge 234, or cutting edge, is vertically lower than the leading edge 232 for each respective airfoil-shaped portion 224. The blade 220 includes a central mounting portion 238 disposed between the airfoil-shaped portions 224 that may be connected to a spindle. A plane 240 (FIG. 9) extends through the mounting portion 238 and generally represents a rotational plane for the blade 220. The leading edge 232 and trailing edge 234 are disposed on opposite sides of the plane 240. Since the cutting blade 220 rotates, the opposite ends of the cutting blade 220 are pitched in different orientations, such that both trailing edges 234 are at a similar height, and both leading edges 232 are at a similar height. The pitched cutting blade 220 helps increase lift along the cutting blade 220. In the illustrated embodiment, the plane 240 is generally horizontal with the leading edges 232 disposed above the plane 240, and the trailing edges 234 disposed below the plane 240.

As shown in FIG. 11, the cutting blade 20 described above may also be used in a relatively larger lawnmower 304 having a mower deck 306 and multiple blades 20. Multiple cutting blades 20 generally provide a larger cutting area than a single cutting blade. In FIG. 11, the cutting blades 20 are not directly mounted to the drive shaft of the engine, but are each connected to a separate drive spindle 310. Various drive transfer systems may be used to transfer power from the drive shaft to each spindle 310, such as a belt and pulley system, sprocket and chain system, or gearing system. Alternatively, the spindles 310 may be individually driven by separate electric or hydraulic motors.

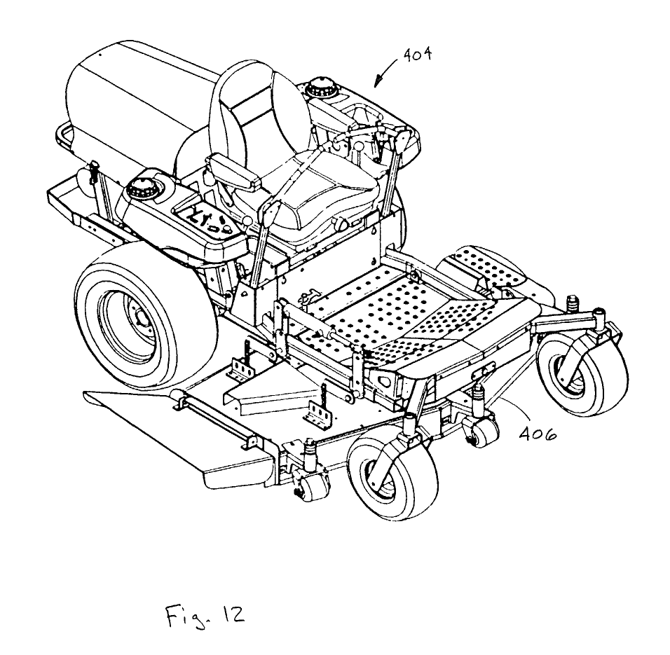

As described above, the cutting blade having an airfoil-shaped portion may also be incorporated into other embodiments, such as a riding lawnmower 404 illustrated in FIG. 12. The riding lawnmower 404 may include a single cutting blade, or multiple cutting blades having an airfoil-shaped portion. The riding lawnmower 404 may include a mower deck 406 and cutting blade configuration similar to the mower deck 306 illustrated in FIG. 11.

In some cases, the illustrated airfoil-shaped rotary cutting blade 20 has been shown to reduce both the noise generated and the power required as the rotary cutting blade operates. A reduction in the power requirement may further result in a reduction in fuel consumption, making the lawnmower more economical to use. In addition, in some cases the airfoil shape may increase the lift produced by the rotation of the blade, causing the grass or other vegetation to stand up as the blade cuts through it. The airfoil shape may also create a flow of air underneath the deck that better discharges the grass or vegetation clippings when compared to known rotary cutting blades.

The foregoing detailed description describes only a few of the many forms that the present invention can take, and should therefore be taken as illustrative rather than limiting. It is only the claims, including all equivalents that are intended to define the scope of the invention.

1. A rotary cutting blade comprising an airfoil-shaped portion having an airfoil leading edge and an airfoil trailing edge, wherein said airfoil trailing edge includes a cutting edge.

2. The blade of claim 1, wherein said airfoil leading edge is generally rounded.

3. The blade of claim 1, wherein said airfoil-shaped portion includes a generally flat portion.

4. The blade of claim 3, wherein said flat portion includes said cutting edge.

5. The blade of claim 3, wherein said airfoil-shaped portion includes an epoxy/plastic compound molded onto said flat portion.

6 The blade of claim 3, wherein said airfoil-shaped portion includes a moldable material co-molded onto said flat portion to create said airfoil shape.

7. The blade of claim 1, wherein said airfoil-shaped portion has a longitudinal extent, and wherein the cross-section of said airfoil-shaped portion is substantially uniform along said longitudinal extent.

8. The blade of claim 1, wherein said airfoil-shaped portion has a center portion, and outer end, and a longitudinal extent that extends from the center portion to the outer end, and wherein the cross-section of said airfoil-shaped portion decreases as the airfoil-shaped portion extends along said longitudinal extent from a center portion to an outer end.

9. The blade of claim 1, wherein said cutting blade is pitched and the trailing edge is vertically lower than the leading edge.

10. The blade of claim 1, wherein said blade is adapted to rotate parallel to a plane, said blade further comprising a transverse member mounted to at least one end of said blade and extending substantially perpendicular to said plane.

11. The blade of claim 10, further comprising a brushing member mounted to said transverse member.

12. The blade of claim 11, wherein said brushing member includes a plurality of plastic lines.

13. The blade of claim 11, wherein said brushing member is supported for rotation on said transverse member.

14. A rotary cutting blade having a length, a width, and a thickness measured perpendicular to both said length and width, said blade comprising a cutting edge and a non-cutting edge, said blade thickness along a cross-section of said blade being a minimum at said cutting edge and increasing along a smooth curve to a maximum thickness between said cutting edge and said non-cutting edge, said thickness decreasing along substantially a smooth curve from said maximum thickness to said non-cutting edge, wherein said non-cutting edge is generally rounded.

15. The blade of claim 14, wherein a portion of said blade has the shape of an airfoil having a leading edge and a trailing edge, and wherein said airfoil trailing edge includes said cutting edge.

16. The blade of claim 14, wherein said blade includes a generally flat portion and a curved portion interconnected with said flat portion to give said blade an airfoil shape.

17. The blade of claim 16, wherein said airfoil-shaped portion includes a leading edge and a trailing edge, and wherein said flat portion defines said cutting edge along said airfoil trailing edge.

18. The blade of claim 16, wherein said curved portion includes an epoxy/plastic compound molded onto said flat portion.

19. The blade of claim 16, wherein said curved portion is co-molded onto said flat portion.

20. The blade of claim 16, wherein the cross-section of said airfoil-shaped portion of said blade is substantially uniform along its length.

21. The blade of claim 14, wherein the cross-sectional maximum thickness of said blade decreases as the blade extends along the length of the blade from a center portion of the blade to an outer end of the blade.

22. The blade of claim 14, wherein said cutting blade is pitched and the trailing edge is vertically lower than the leading edge.

23. The blade of claim 14, wherein said blade is adapted to rotate parallel to a plane of rotation, said blade further comprising a transverse member mounted to at least one end of said blade and extending substantially perpendicular to the plane of rotation of said blade.

24. The blade of claim 23, further comprising a brushing member mounted to said transverse member.

25. The blade of claim 24, wherein said brushing member includes a plurality of plastic lines.

26. The blade of claim 24, wherein said brushing member is supported for rotation on said transverse member.

27. A lawnmower comprising:
a deck;
wheels supporting said deck;
an engine mounted to said deck;
a drive shaft rotating in response to operation of said engine and extending below said deck; and
a rotary cutting blade mounted below said deck and rotatable parallel to a cutting plane in response to rotation of said drives shaft;
wherein a portion of said rotary cutting blade is shaped like an airfoil having leading and trailing edges, and wherein said trailing edge of said airfoil-shaped portion includes a cutting edge of said rotary cutting blade, and wherein said drive shaft rotates said rotary cutting blade such that said airfoil trailing edge rotates in front of said airfoil leading edge.

28. The lawnmower of claim 27, wherein said rotary cutting blade includes a flat portion and a curved portion affixed to said flat portion to give said rotary cutting blade an airfoil shape.

29. The lawnmower of claim 28, wherein said curved portion is molded onto said flat portion.

30. The lawnmower of claim 27, wherein the cross-section of said airfoil-shaped portion is substantially constant along its length.

31. The lawnmower of claim 27, wherein the cross-section of said airfoil-shaped portion decreases as the airfoil-shaped portion extends from a center portion of the airfoil-shaped portion to an outer end of the airfoil-shaped portion.

32. The lawnmower of claim 27, wherein said cutting blade is pitched and the trailing edge is vertically lower than the leading edge.

33. The lawnmower of claim 27, wherein said leading edge of said airfoil-shaped portion is generally rounded.

34. The lawnmower of claim 27, wherein said rotary cutting blade includes a transverse member on the end of said rotary cutting blade and extending substantially perpendicular to said cutting plane.

35. The lawnmower of claim 34, wherein said deck includes a depending flange around said rotary cutting blade, said flange including an inner surface facing said rotary cutting blade, said lawnmower further comprising a cleaning brush supported by said transverse member and contacting said inner surface of said flange to clean said inner surface as said rotary cutting blade rotates.

36. The lawnmower of claim 35, wherein said cleaning brush includes a plurality of plastic lines that contact said inner surface of said flange.

37. The lawnmower of claim 35, wherein said brushing member is supported for rotation with respect to said transverse member.

38. The lawnmower of claim 27, further comprising multiple rotary cutting blades.

39. A method for cutting vegetation comprising:
providing an airfoil-shaped rotary cutting blade having an airfoil leading edge and an airfoil trailing edge;
defining a cutting edge in the airfoil trailing edge;
rotating the blade such that the airfoil trailing edge is in front of said airfoil leading edge; and
cutting the vegetation with the cutting edge of the blade.

40. The method of claim 39, wherein said providing step includes:
providing a rigid metal blade portion; and
interconnecting a curved portion to the rigid metal blade portion to give the blade the shape of an airfoil.

41. The method of claim 40, wherein said defining step includes defining a cutting edge in the rigid metal blade portion.

42. The method of claim 40, wherein said interconnecting step includes molding a material onto the rigid metal blade portion.

43. The method of claim 42, wherein said interconnecting step further includes molding an epoxy/plastic compound onto the blade portion.

44. The method of claim 39, wherein said providing step includes creating a single-piece blade in the shape of an airfoil.

45. The method of claim 39, wherein said providing step includes interconnecting a transverse member at an end of the blade, interconnecting a brush member to the transverse member, the method further comprising the steps of surrounding the blade with a shroud having an inner surface facing the blade, and cleaning the inner surface with the brush member as the blade rotates within the shroud.

46. The method of claim 39, further comprising creating a pressure differential above and below the blade in response to rotation of the blade such that vegetation below the blade is lifted toward the blade.

47. The method of claim 39, wherein said providing step includes providing said cutting blade having a cross-section that decreases as the airfoil-shaped portion extends outwardly from a center portion of the cutting blade to an outer end of the cutting blade.

48. The method of claim 39, wherein said providing step includes pitching said cutting blade such that the trailing edge is vertically lower than the leading edge.
